(19) United States
(12) Patent Application Publication
(10) Pub. No.: US 2025/0018738 A1
(43) Pub. Date: Jan. 16, 2025

(54) IMAGE FORMATION DEVICE

(71) Applicant: BROTHER KOGYO KABUSHIKI KAISHA, Nagoya (JP)

(72) Inventors: Yugo FUKUI, Kariya (JP); Akihito KOBAYASHI, Konan (JP); Noriyuki KAWAMATA, Nagoya (JP)

(21) Appl. No.: 18/901,352

(22) Filed: Sep. 30, 2024

Related U.S. Application Data
(63) Continuation of application No. PCT/JP2023/010593, filed on Mar. 17, 2023.

(30) Foreign Application Priority Data
Mar. 31, 2022 (JP) 2022-060613

(51) Int. Cl. B41J 29/377; B41J 2/175; B41J 3/407; B41J 11/06

(52) U.S. Cl. CPC B41J 29/377; B41J 2/17503; B41J 3/4078; B41J 11/06

(57) ABSTRACT

An image formation device includes a head and a cooling portion. The head is configured to discharge ink. The cooling portion is configured to cool a pre-treatment agent. The pre-treatment agent contains a volatile component having volatility, and reacting with the ink.

### REFERENCE TO RELATED APPLICATIONS

This application is a Continuation Application of International Application No. PCT/JP2023/010593, filed on Mar. 17, 2023, which claims priority from Japanese Patent Application No. 2022-060613, filed on Mar. 31, 2022. This disclosure of the foregoing application is hereby incorporated by reference in its entirety.

### BACKGROUND ART

A printer is known that, in order to improve fixing of ink discharged onto a print medium, applies a pre-treatment agent to the print medium before discharging the ink. The printer applies the pre-treatment agent to a cloth, and discharges the ink onto the cloth in a state of being wet with the applied pre-treatment agent.

### SUMMARY

There is a possibility that the pre-treatment agent applied to the cloth may be volatilized when discharging the ink. If the volatilized pre-treatment agent attaches to an inkjet nozzle discharging the ink, the attached pre-treatment agent reacts with the ink inside the inkjet nozzle, and the ink may become viscous or solidify. In this case, there is a possibility that it may become difficult for the inkjet nozzle to discharge the ink. Further, for example, there is a problem that the ink inside the inkjet nozzle may react with the pre-treatment agent and a color change may occur.

Embodiments of the broad principles derived herein provide an image formation device that suppresses a pre-treatment agent applied to a recording medium from being volatilized and reacting with ink inside a head, even when a pre-treatment agent contains volatile components.

An image formation device of the present disclosure includes a head and a cooling portion. The head is configured to discharge ink. The cooling portion is configured to cool a pre-treatment agent. The pre-treatment agent contains a volatile component having volatility, and reacting with the ink.

According to the above-described aspect, the cooling portion cools the pre-treatment agent. In this way, the pre-treatment agent applied to a recording medium is less likely to be volatilized, compared to when the pre-treatment agent is not cooled. Thus, the image formation device can suppress the pre-treatment agent from being volatilized and reacting with the ink inside the head even when the pre-treatment agent contains the volatile component.

### BRIEF DESCRIPTION OF DRAWINGS

FIG. 1 is a perspective view of an image formation device.

FIG. 2 is a view showing a path configuration for supplying a pre-treatment agent, and a path configuration for cooling the pre-treatment agent.

FIG. 3 is a block diagram showing an electrical configuration of the image formation device.

FIG. 4 is a flowchart of cooling control processing.

FIG. 5 is a view illustrating a presetting table.

### DESCRIPTION

### <Overall Configuration of Image Formation Device 1>

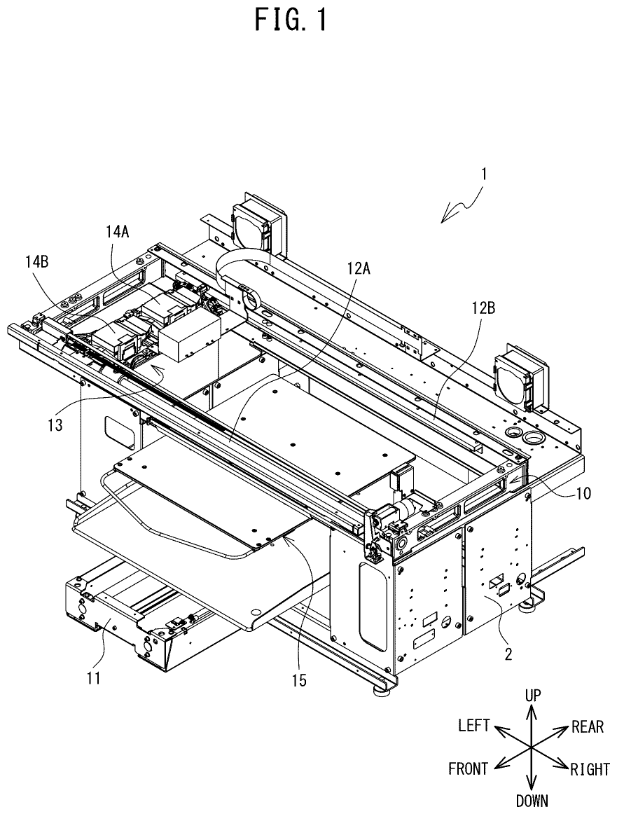

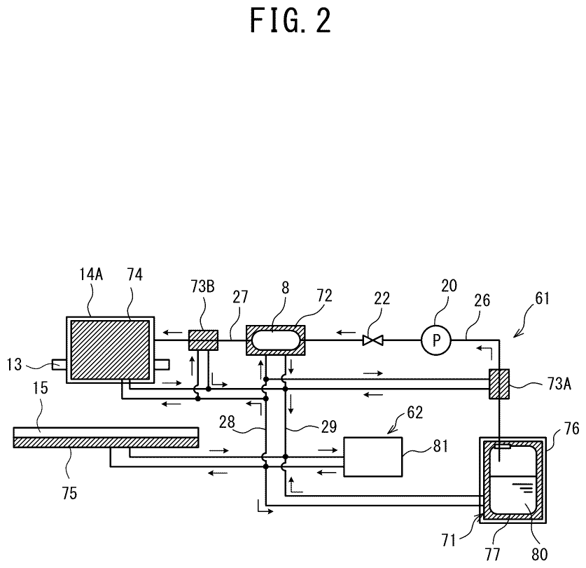

An image formation device 1 that is an embodiment of the present disclosure will be described. In the present embodiment, structural elements in the drawings indicate an actual scale in each of the drawings. For example, the image formation device 1 shown in FIG. 1 is an inkjet printer. The image formation device 1 discharges ink or a pre-treatment agent 80 shown in FIG. 2 onto a recording medium that is not shown in the drawings, and performs printing. The recording medium is a cloth, paper, or the like, and is a T-shirt, for example.

The ink is, for example, white (W), black (K), yellow (Y), cyan (C), or magenta (M). Hereinafter, of the five colors of the ink, the white ink will be referred to as “white ink”. Of the five colors of the ink, when the four colors of the ink of black, cyan, yellow and magenta are collectively referred to, or when one of those colors is not specified, they will be referred to as “color inks”.

The white ink is used for printing a portion representing white in an image, or as a background for the color inks. The color inks are used for printing a color image. The color inks are discharged directly onto the recording medium, or are discharged onto the background created by the white ink.

The pre-treatment agent 80 is a base coat agent, for example. The pre-treatment agent 80 is applied to the recording medium before printing using the color inks or the white ink. The pre-treatment agent 80 applied to the recording medium reacts with the ink. The pre-treatment agent 80 that has reacted with the ink causes the ink to be fixed to the recording medium or improves color development of the ink. The pre-treatment agent 80 contains formic acid or acetic acid, for example, as a component that reacts with ink. The formic acid or the acetic acid is highly volatile and the pre-treatment agent 80 has volatility. In the present embodiment, the “pre-treatment agent 80 reacts with the ink” means that the pre-treatment agent 80 causes the ink to be viscous, or the pre-treatment agent 80 causes the ink to solidify.

### <Mechanical Configuration of Image Formation Device 1>

Hereinafter, the upper left direction, the lower right direction, the lower left direction, the upper right direction, the upward direction, and the downward direction in FIG. 1 are, respectively, the leftward direction, the rightward direction, the forward direction, the rearward direction, the upward direction, and the downward direction of the image formation device 1.

As shown in FIG. 1, the image formation device 1 is provided with a housing 2, a frame body 10, a conveyance portion 11, a platen 15, a guide shaft 12A, a rail 12B, a carriage 13, heads 14A and 14B. The frame body 10 has a rectangular frame shape in a plan view, and is disposed at an upper portion of the housing 2. The frame body 10 supports each of the guide shaft 12A at the front, and the rail 12B at the rear, respectively. The guide shaft 12A extends in the left-right direction inside the frame body 10. The rail 12B is disposed facing the guide shaft 12A, and extends in the left-right direction. The carriage 13 is configured to be conveyed in the left-right direction along the guide shaft 12A.

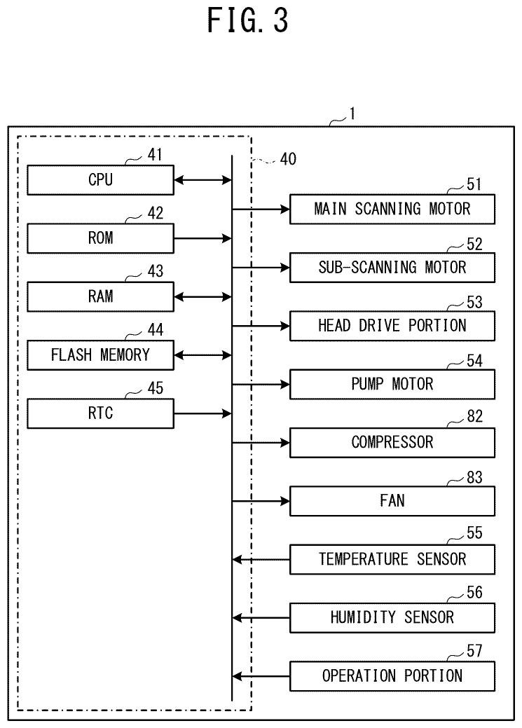

The conveyance portion 11 includes a shaft extending in the front-rear direction, for example. The platen 15 is positioned above the conveyance portion 11, and is supported by the conveyance portion 11. The platen 15 has a plate shape and extends orthogonally to the up-down direction. The recording medium is placed on the upper surface of the platen 15. The platen 15 is conveyed in the front-rear direction along the conveyance portion 11, by the driving of a sub-scanning motor 52 shown in FIG. 3. Thus, in the present embodiment, the front-rear direction of the image formation device 1 is a sub-scanning direction.

The heads 14A and 14B are mounted to the carriage 13. Hereinafter, when the head 14A and the head 14B are not distinguished from each other, they will be referred to as the “head 14”. The lower surface of the head 14 is positioned higher than the platen 15, and is exposed downward from the carriage 13. A plurality of nozzles that are not shown in the drawings are provided in the lower surface of the head 14. The head 14 discharges the ink or the pre-treatment agent 80 from the plurality of nozzles as a result of the driving of a head drive portion 53 shown in FIG. 3. The head drive portion 53 is configured by a piezoelectric elements or heating elements, for example. The head 14A discharges the pre-treatment agent 80. The pre-treatment agent 80 is supplied to the head 14A from a tank 77 shown in FIG. 2. The head 14B discharges the color inks. The color inks are supplied to the head 14B from tanks that are not shown in the drawings.

The carriage 13 is conveyed in the left-right direction along the guide shaft 12A and the rail 12B as a result of the driving of a main scanning motor 51 shown in FIG. 3. In this way, the head 14 is also conveyed in the left-right direction. Thus, in the present embodiment, the left-right direction of the image formation device 1 is a main scanning direction.

As shown in FIG. 2, the image formation device 1 is provided with the tank 77 that stores the pre-treatment agent 80. The tank 77 is covered by a heat insulating material 76. The heat insulating material 76 is a member for preventing heat transfer by at least one of conduction, convection or radiation. The heat insulating material 76 is polyethylene foam, for example. The heat insulating material 76 suppresses the temperature of the pre-treatment agent 80 from rising as a result of the heat of the atmosphere around the tank 77. Note that the material of the heat insulating material 76 is not limited to the polyethylene foam, and may be another foamed insulating material. Further, the heat insulating material 76 may be a fiber based insulating material, such as glass wool, rock wool and the like. In addition to this, the heat insulating material 76 may be a container adopting a vacuum chamber between an outer layer and an inner layer.

### <Flow Path Configuration for Supplying Pre-Treatment Agent 80>

A flow path configuration for supplying the pre-treatment agent 80 from the tank 77 to the head 14A will be described with reference to FIG. 2. A pre-treatment agent supply portion 61 supplies the pre-treatment agent 80 from the tank 77 to the head 14A. The pre-treatment agent supply portion 61 is provided with a sub-pouch 8, pre-treatment agent flow paths 26 and 27, a pump 20, a valve 22, and filters that are not shown in the drawings.

The sub-pouch 8 is bag shaped. The pre-treatment agent supply paths 26 and 27 are hollow tubes, for example. The pre-treatment agent flow path 26 connects the tank 77 and the sub-pouch 8. The pre-treatment agent flow path 27 connects the sub-pouch 8 and the head 14A.

The pump 20 is provided in the pre-treatment agent flow path 26. The pump 20 is driven by a pump motor 54 shown in FIG. 3. The pump 20 suctions the pre-treatment agent 80 from the tank 77 and transfers the pre-treatment agent 80 to the head 14A via the pre-treatment agent flow path 26, the sub-pouch 8, and the pre-treatment agent flow path 27. The sub-pouch 8 stores the pre-treatment agent 80 transferred from the tank 77.

The valve 22 is provided downstream of the pump 20 in the pre-treatment agent flow path 26. The valve 22 opens and closes the pre-treatment agent flow path 26. The filters are provided in the pre-treatment agent flow paths 26 and 27, and filter the pre-treatment agent 80.

### <Overview of Pre-Treatment Processing, Print Processing>

The image formation device 1 performs pre-treatment processing before print processing. Before the pre-treatment processing is performed, a user places the recording medium on the platen 15. For example, in the pre-treatment processing, the image formation device 1 causes the carriage 13 to reciprocate in the left-right direction by the driving of the main scanning motor 51 shown in FIG. 3, while moving the platen 15 in the front-rear direction by the driving of the sub-scanning motor 52 shown in FIG. 3. The head 14A discharges the pre-treatment agent 80 supplied from the tank 77 while moving in the left-right direction. In this way, the pre-treatment agent 80 is applied to the recording medium placed on the platen 15.

Subsequent to the pre-treatment processing, the image formation device 1 performs the print processing. Note that, in the present embodiment, since the image formation device 1 does not include a heat processing mechanism that heats the recording medium subsequent to the pre-treatment processing, the recording medium is in a state of being wet with the pre-treatment agent 80. For example, in the print processing, the image formation device 1 causes the carriage 13 to reciprocate in the left-right direction by the driving of the main scanning motor 51 shown in FIG. 3, while moving the platen 15 in the front-rear direction by the driving of the sub-scanning motor 52 shown in FIG. 3. The head 14B discharges the inks supplied from the tanks that are not shown in the drawings while moving in the left-right direction. In this way, a print image is printed on the recording medium placed on the platen 15.

<Configuration for Suppressing Volatilization of Pre-Treatment Agent 80 from Recording Medium>

In order to suppress the volatilization of the pre-treatment agent 80 applied to the recording medium, the image formation device 1 cools the pre-treatment agent 80 using cooling portions 71 to 75. Hereinafter, when the cooling portions 71 to 75 are referred to collectively, or are not distinguished from each other, they will be collectively referred to as the cooling portions 70 or cooling portion 70. The cooling portions 70 cool the pre-treatment agent 80 using a coolant. The coolant is a hydrofluorocarbon, for example.

The cooling portion 71 is provided between the heat insulating material 76 and the tank 77. By cooling the tank 77, the cooling portion 71 cools the pre-treatment agent 80 stored in the tank 77. Note that the heat insulating material 76 provided around the tank 77 suppresses the temperature of the pre-treatment agent 80 cooled by the cooling portion 71 from rising as a result of the heat of the atmosphere around the tank 77.

The cooling portion 72 covers the periphery of the sub-pouch 8. The cooling portion 72 cools the pre-treatment agent 80 stored in the sub-pouch 8. The cooling portion 73A is provided at the pre-treatment agent flow path 26. The cooling portion 73A cools the pre-treatment agent 80 inside the pre-treatment agent flow path 26. The cooling portion 73B is provided at the pre-treatment agent flow path 27. The cooling portion 73B cools the pre-treatment agent 80 inside the pre-treatment agent flow path 27. The cooling portion 74 is provided at the head 14A. The cooling portion 74 cools the pre-treatment agent 80 inside the head 14A. The cooling portion 75 is fixed to the lower surface of the platen 15. The cooling portion 75 cools the pre-treatment agent 80 applied to the recording medium, via the platen 15.

A coolant circulation portion 62 supplies the coolant to the cooling portions 70. The coolant circulation portion 62 is provided with coolant flow paths 28 and 29, and a heat exchanger 81. The coolant flow paths 28 and 29 are hollow tubes, for example. The coolant flow paths 28 and 29 connect the cooling portions 70 and the heat exchanger 81. The heat exchanger 81 is provided with a compressor 82 shown in FIG. 3, a condenser that is not shown in the drawings, a fan 83 shown in FIG. 3, and an expansion valve that is not shown in the drawings. The compressor 82 compresses the coolant. The condenser and the fan 83 dissipate heat from the compressed coolant. The expansion valve adjusts the pressure of the coolant from which the heat has been dissipated, and cools the coolant.

The coolant cooled by the heat exchanger 81 is transferred to the cooling portions 70 from the heat exchanger 81 via the coolant flow path 28. The coolant used for cooling the pre-treatment agent 80 by the cooling portions 70 is transferred to the heat exchanger 81 from the cooling portions 70 via the coolant flow path 29. The coolant transferred to the heat exchanger 81 via the coolant flow path 29 is cooled by the heat exchanger 81. In other words, the coolant is circulated between the cooling portions 70 and the heat exchanger 81 via the coolant flow paths 28 and 29.

### <Electrical Configuration of Image Formation Device 1>

As shown in FIG. 3, the image formation device 1 is provided with a control device 40. The control device 40 is fixed to the frame body 10, and is provided with a CPU 41, a ROM 42, a RAM 43, a flash memory 44, and an RTC 45. The CPU 41 controls the image formation device 1, and functions as a processor. The CPU 41 controls the pre-treatment processing and the print processing, for example. The CPU 41 is electrically connected to the ROM 42, the RAM 43, the flash memory 44, and the RTC 45.

The ROM 42 stores a control program used by the CPU 41 to control the operations of the image formation device 1, and various information and the like necessary for the CPU 41 when executing various programs. The RAM 43 temporarily stores various data and the like used by the control program. The flash memory 44 is a non-volatile memory, and stores various settings and the like of the image formation device 1. The RTC 45 clocks a current time, as an internal clock of the image formation device 1.

The CPU 41 is electrically connected to the main scanning motor 51, the sub-scanning motor 52, the head drive portion 53, the pump motor 54, the compressor 82, the fan 83, a temperature sensor 55, a humidity sensor 56, and an operation portion 57. The main scanning motor 51, the sub-scanning motor 52, the head drive portion 53, the compressor 82, and the fan 83 are driven under the control of the CPU 41.

The temperature sensor 55 is provided at the pre-treatment agent flow path 27. The temperature sensor 55 detects a temperature T of the pre-treatment agent 80 inside the pre-treatment agent flow path 27. The temperature sensor 55 outputs a signal indicating the detected temperature T to the CPU 41. The humidity sensor 56 is provided at the frame body 10. The humidity sensor 56 detects a humidity H inside the housing 2 of the image formation device 1. The humidity sensor 56 outputs a signal indicating the detected humidity H to the CPU 41. Note that a position at which the temperature sensor 55 is provided is not limited to being at the pre-treatment agent flow path 27. The temperature sensor 55 may detect the temperature of the pre-treatment agent 80 before discharge, at a location different from the pre-treatment agent flow path 27. The temperature sensor 55 may be provided at the tank 77, the pre-treatment agent flow path 26, the sub-pouch 8, or the head 14A, for example.

The operation portion 57 is a touch panel display or the like, and displays various information and outputs information to the CPU 41 in accordance with an operation by the user. By operating the operation portion 57, the user can input, to the image formation device 1, a pre-treatment processing command for starting the pre-treatment processing by the image formation device 1 and the like.

### <Preliminary Preparation>

Based on an operating time of the image formation device 1 in a day, the user determines a cooling start timing, which is a timing to start the temperature control of the pre-treatment agent 80. The operating time of the image formation device 1 is, for example a time period during which the pre-treatment processing and the print processing are performed. For example, the user determines, as the cooling start timing, a timing one hour before a planned timing to first start the pre-treatment processing in the one day. The user inputs the determined cooling start timing into the image formation device 1 by operating the operation portion 57. The CPU 41 makes the flash memory 44 store the input cooling start timing.

Further, based on the operating time of the image formation device 1 in the one day, the user determines a cooling end timing, which is a timing to end the temperature control of the pre-treatment agent 80. For example, the user determines, as the cooling end timing, a timing that is 30 minutes after a timing at which all of the print processing in the one day has ended. The user input the determined cooling end timing to the image formation device 1 by operating the operation portion 57. CPU 41 makes the flash memory 44 store the input cooling end timing.

### <Cooling Control Processing>

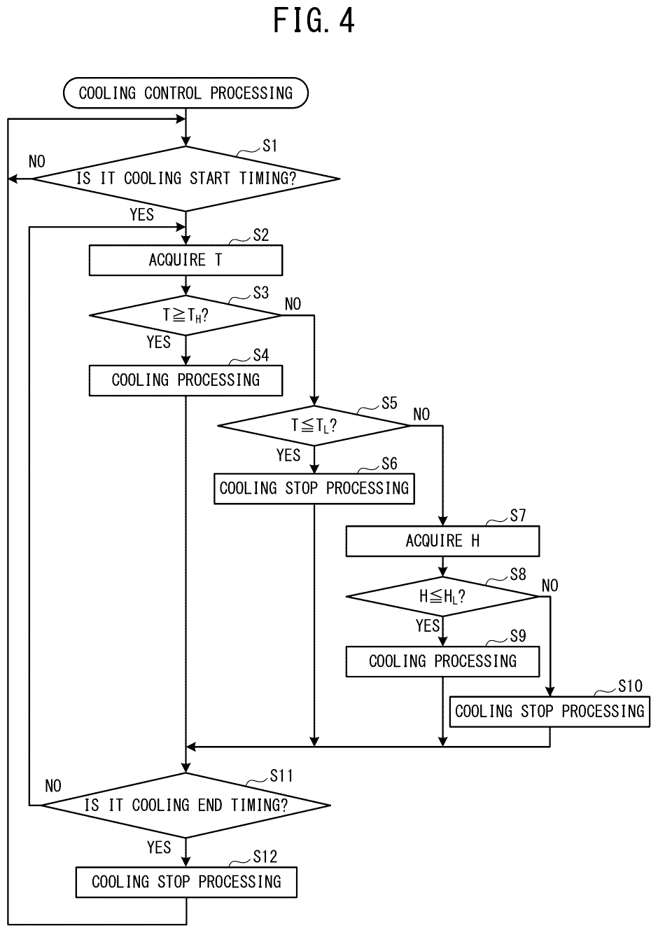

The CPU 41 performs control to start the cooling of the pre-treatment agent 80 by the cooling portions 70, by executing cooling control processing shown in FIG. 4. For example, when a power supply to the image formation device 1 is turned on in a state in which the cooling start timing and the cooling end timing are stored in the flash memory 44, the CPU 41 reads out the control program from the ROM 42, and executes the cooling control processing.

When the cooling control processing is started, as shown in FIG. 4, the CPU 41 determines, based on the RTC 45, whether or not the current time coincides with the cooling start timing stored in the flash memory 44 (S1). When it is determined that the current time does not coincide with the cooling start timing (no at S1), the CPU 41 returns the processing to S1. When it is determined that the current time coincides with the cooling start timing (yes at S1), the CPU 41 acquires the temperature T from the temperature sensor 55 (S2). The CPU 41 determines whether or not the temperature T is equal to or higher than an upper limit temperature T_{H} (S3). The upper limit temperature T_{H} is a threshold value used by the CPU 41 to determine whether or not the cooling of the pre-treatment agent 80 is to be started or continued, and is stored in the flash memory 44.

When it is determined that the temperature T is equal to or higher than the upper limit temperature T_{H} (yes at S3), the CPU 41 executes cooling processing (S4). In the cooling processing, the CPU 41 drives the compressor 82 and the fan 83. The coolant is circulated between the cooling portions 70 and the heat exchanger 81, and the cooling portions 70 cool the pre-treatment agent 80. The CPU 41 shifts the processing to S11.

When it is determined that the temperature T is lower than the upper limit temperature T_{H} (no at S3), the CPU 41 determines whether or not the temperature T is equal to or lower than a lower limit temperature T_{L} (S5). The lower limit temperature T_{L} is a threshold value used by the CPU 41 to determine whether or not the cooling of the pre-treatment agent 80 is to be stopped, and is stored in the flash memory 44. The lower limit temperature T_{L} is higher than a solidifying point of the pre-treatment agent 80. The solidifying point of the pre-treatment agent 80 is 0° C., for example.

When it is determined that the temperature T is equal to or lower than the lower limit temperature T_{L} (yes at S5), the CPU 41 executes cooling stop processing (S6). In the cooling stop processing, the CPU 41 stops the driving of the compressor 82 and the fan 83. The circulation of the coolant between the cooling portions 70 and the heat exchanger 81 is stopped, and the cooling portions 70 stop cooling the pre-treatment agent 80. The CPU 41 shifts the processing to S11.

When it is determined that the temperature T is higher than the lower limit temperature T_{L} (no at S5), the CPU 41 acquires the humidity H from the humidity sensor 56 (S7). The CPU 41 determines whether or not the humidity H is equal to or lower than a lower limit humidity H_{L} (S8). The lower limit humidity HI, is a threshold value used by the CPU 41 to determine whether the cooling of the pre-treatment agent 80 is to be started or continued, and is stored in the flash memory 44.

When it is determined that the humidity H is equal to or lower than the lower limit humidity H_{L} (yes at S8), the CPU 41 executes the cooling processing (S9). The cooling processing executed at S9 is the same as the cooling processing executed at S4. The CPU 41 shifts the processing to S11. When it is determined that the humidity H is higher than the lower limit humidity H_{L} (no at S8), the CPU 41 executes the cooling stop processing (S10). The cooling stop processing executed at S10 is the same as the cooling stop processing executed at S6. The CPU 41 shifts the processing to S11.

Based on the RTC 45, the CPU 41 determines whether or not the current time coincides with the cooling end timing stored in the flash memory 44 (S11). When it is determined that the current time does not coincide with the cooling end timing (no at S11), the CPU 41 returns the processing to S2. When it is determined that the current time coincides with the cooling end timing (yes at S11), the CPU 41 executes the cooling stop processing (S12). The cooling stop processing executed at S12 is the same as the cooling stop processing executed at S6 and S10. The CPU 41 returns the processing to S1.

Note that the formic acid and acetic acid are an example of a “volatile component” of the present disclosure. The head 14A is an example of a “discharge portion” of the present disclosure. The tank 77 and the sub-pouch 8 are an example of a “storage portion” of the present disclosure. The pre-treatment agent flow paths 26 and 27 are an example of a “flow path” of the present disclosure. The CPU 41 is an example of a “processor”
of the present disclosure. The temperature sensor 55 is an example of a “thermometer” of the present disclosure. The humidity sensor 56 is an example of a “hygrometer” of the present disclosure. The one day is an example of a “predetermined time period” of the present disclosure.

### <Actions and Effects of Present Embodiment>

In the image formation device 1, the cooling portions 70 cool the pre-treatment agent 80. As a result, the pre-treatment agent 80 applied to the recording medium is less likely to be volatilized, compared to when the pre-treatment agent 80 is not cooled. Thus, the image formation device 1 can suppress the ink inside the head 14B from reacting with the volatilized pre-treatment agent 80. Thus, the image formation device 1 can suppress a situation in which it is difficult to discharge the ink from the head 14B.

In the image formation device 1, the cooling portions 71 to 74 cool the pre-treatment agent 80 before being discharged from the head 14A. The cooled pre-treatment agent 80 is discharged from the head 14A, and thus, the pre-treatment agent 80 after being discharged is less likely to be volatilized, compared to when the pre-treatment agent 80 is not cooled before being discharged. Thus, the image formation device 1 can suppress the pre-treatment agent 80 from being volatilized and reacting with the ink inside the head 14B.

In the image formation device 1, the cooling portion 71 cools the pre-treatment agent 80 stored in the tank 77. The cooling portion 72 cools the pre-treatment agent 80 stored in the sub-pouch 8. Since the pre-treatment agent 80 cooled in the tank 77 and the sub-pouch 8 is discharged from the tank 77 and the sub-pouch 8, the pre-treatment agent 80 after discharge is less likely to be volatilized, compared to when the pre-treatment agent 80 is not cooled in the tank 77. Thus, the image formation device 1 can suppress the pre-treatment agent 80 from being volatilized and reacting with the ink inside the head 14B.

The heat insulating material 76 suppresses the temperature of the pre-treatment agent 80 stored in the tank 77 from rising as a result of the heat of the surrounding atmosphere. The pre-treatment agent 80 cooled by the cooling portion 71 in the tank 77 is discharged from the tank 77 in a state in which the temperature rise by the surrounding atmosphere has been suppressed. Thus, the pre-treatment agent 80 after being discharged is less likely to be volatilized, compared to the pre-treatment agent 80 cooled in the tank 77 that is not covered by the heat insulating material 76. Thus, the image formation device 1 can suppress the pre-treatment agent 80 from being volatilized and reacting with the ink inside the head 14B.

In the image formation device 1, the cooling portion 73A cools the pre-treatment agent 80 inside the pre-treatment agent flow path 26. The cooling portion 73B cools the pre-treatment agent 80 inside the pre-treatment agent flow path 27. In the image formation device 1, the pre-treatment agent 80 that has been cooled in the pre-treatment agent flow paths 26 and 27 is discharged. Thus, the discharged pre-treatment agent 80 is less likely to be volatilized, compared to when the pre-treatment agent 80 is not cooled in the pre-treatment agent flow paths 26 and 27. Thus, the image formation device 1 can suppress the pre-treatment agent 80 from being volatilized and reacting with the ink inside the head 14B.

In the image formation device 1, the cooling portion 74 cools the pre-treatment agent 80 inside the head 14A. In the image formation device 1, the pre-treatment agent 80 that has been cooled in the head 14A is discharged. Thus, the discharged pre-treatment agent 80 is less likely to be volatilized, compared to when the pre-treatment agent 80 is not cooled in the head 14A. Thus, the image formation device 1 can suppress the pre-treatment agent 80 from being volatilized and reacting with the ink inside the head 14B.

In the image formation device 1, the platen 15 supports the recording medium to which the pre-treatment agent 80 has been applied. The cooling portion 75 cools the pre-treatment agent 80 that has been applied to the recording medium, via the platen 15. Thus, the pre-treatment agent 80 that has been applied to the recording medium is less likely to be volatilized in the state of being applied to the recording medium, compared to when the pre-treatment agent 80 is not cooled via the platen 15. Thus, the image formation device 1 can suppress the pre-treatment agent 80 from being volatilized and reacting with the ink inside the head 14B.

In the image formation device 1, when it is determined that the temperature Tis equal to or higher than the upper limit temperature T_{H} (yes at S3), the CPU 41 executes the cooling processing (S4). When it is determined that the humidity H is equal to or lower than the lower limit humidity H_{L} (yes at S8), the CPU 41 executes the cooling processing (S9). The temperature T is detected by the temperature sensor 55. The humidity H is detected by the humidity sensor 56. In this way, the CPU 41 causes the cooling portions 70 to cool the pre-treatment agent 80 based on the temperature T or the humidity H. As a result, even in an atmosphere in which the pre-treatment agent 80 is likely to be volatilized, the pre-treatment agent 80 applied to the recording medium is cooled by the cooling portions 70 and is less likely to be volatilized. Thus, the image formation device 1 can suppress the pre-treatment agent 80 from being volatilized and reacting with the ink inside the head 14B.

In the image formation device 1, when the current time is between the cooling start timing and the cooling end timing, the CPU 41 executes the temperature control of the pre-treatment agent 80 by the cooling portions 70. The cooling start timing and the cooling end timing are determined based on the operating time of the image formation device 1 in the one day. In this way, the image formation device 1 can reduce power consumption of the cooling portions 70, since the cooling of the pre-treatment agent 80 is not performed during time periods other than the operating time.

In the image formation device 1, when it is determined that the temperature Tis equal to or lower than the lower limit temperature T_{L} (yes at S5), the CPU 41 executes the cooling stop processing (S6). The lower limit temperature T_{L} is higher than the solidifying point of the pre-treatment agent 80. By executing the cooling stop processing, the CPU 41 executes the cooling control of the pre-treatment agent 80 such that the temperature T is higher than the solidifying point of the pre-treatment agent 80. In this way, the image formation device 1 can suppress the pre-treatment agent 80 from solidifying due to the cooling. Thus, the image formation device 1 can suppress the pre-treatment agent 80 from solidifying due to the cooling and from being difficult to apply to the recording medium. Alternatively, the image formation device 1 can suppress a situation in which the pre-treatment agent 80 solidifies and it becomes difficult to apply the pre-treatment agent 80 to the recording medium.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

### Modified Examples

Various changes can be made to the present disclosure from the above-described embodiment. Various modified examples to be described below can be combined with each other insofar as no contradictions arise. As the highly volatile component, the pre-treatment agent 80 may contain a substance other than the formic acid and the acetic acid. Further, the substance that is highly volatile in this way need not necessarily cause the ink to become viscous or to solidify. For example, the pre-treatment agent 80 may react with the ink and cause the ink to change color.

The configuration of the image formation device 1 is not limited to that of the above-described embodiment. The pre-treatment agent 80 need not necessarily be discharged from the head 14A. For example, the pre-treatment agent 80 may be applied to the recording medium by a spray, a stamp, a brush, a roller, or the like.

The pre-treatment agent 80 may be volatile and contain a component that reacts with the ink. The pre-treatment agent 80 may contain a component that causes the ink to change color, and need not necessarily contain a component that causes the ink to become viscous, or a component that causes the ink to solidify.

The image formation device 1 may be configured such that a cartridge, which houses a tank storing the pre-treatment agent 80, is installed into and removed from the image formation device 1. The pre-treatment agent 80 may be supplied to the head 14A from the tank of the cartridge installed in the image formation device 1. The image formation device 1 need not necessarily be provided with the sub-pouch 8 storing the pre-treatment agent 80. The cooling portion 70 may be provided at only one of the pre-treatment agent flow paths 26 and 27. The cooling portions 70 need not necessarily be provided at the pre-treatment agent flow paths 26 and 27.

In place of the heat insulating material 76, for example, the tank 77 may be covered by a structural body having a double wall structure, such as a Dewar vessel. The tank 77 need not necessarily be provided with the heat insulating material 76. The sub-pouch 8 may be covered by a heat insulating material. A temperature rise of the pre-treatment agent 80 stored in the sub-pouch 8 may be suppressed by the heat insulating material. The pre-treatment agent flow paths 26 and 27 may be covered by a heat insulating material. A temperature rise of the pre-treatment agent 80 inside the pre-treatment agent flow paths 26 and 27 may be suppressed by the heat insulating material. A section of the head 14A other than the nozzles may be covered by a heat insulating material. A temperature rise of the pre-treatment agent 80 inside the head 14A may be suppressed by the heat insulating material. A heat insulating material may be provided on at least one of the cooling portions 71 to 75.

The configuration of the cooling portion 70 is not limited to that of the above-described embodiment. It is sufficient that the image formation device 1 be provided with at least one of the cooling portions 71 to 75. A state of the coolant that cools the pre-treatment agent 80 may be one of a solid, a liquid, or a gas. The cooling portions 70 need not necessarily cool the pre-treatment agent 80 using the circulated coolant. The cooling portions 70 may cool the pre-treatment agent 80 using a thermoelectric cooling method, which uses a Peltier element or the like, for example. The cooling portion 71 may be provided inside the tank 77. In this case, the cooling portion 71 may cool the pre-treatment agent 80 from the inside of the tank 77. Further, the cooling portion 71 may be provided both inside and outside the tank 77. The cooling portion 72 may be provided inside the sub-pouch 8. In this case, the cooling portion 72 may cool the pre-treatment agent 80 from the inside of the sub-pouch 8. Further, the cooling portion 72 may be provided both inside and outside the sub-pouch 8. The cooling portion 73A may cool the pre-treatment agent 80 from the outside of the pre-treatment agent flow path 26, or may cool the pre-treatment agent 80 from the inside of the pre-treatment agent flow path 26. The cooling portion 73B may cool the pre-treatment agent 80 from the outside of the pre-treatment agent flow path 27, or may cool the pre-treatment agent 80 from the inside of the pre-treatment agent flow path 27. The cooling portion 74 may cool the pre-treatment agent 80 from the outside of the head 14A, or may cool the pre-treatment agent 80 from the inside of the head 14A. The cooling portion 75 may cool the pre-treatment agent 80 applied to the recording medium placed on the platen 15 by blowing cold air against the recording medium placed on the platen 15, for example. The configurations of the cooling portions 71 to 75 may be the same as each other, or may be different from each other.

The CPU 41 need not necessarily execute the cooling processing or the cooling stop processing based on the temperature T and the humidity H. In this case, the CPU 41 may omit S2, S3, and S5 to S10 in the cooling processing. The CPU 41 may execute the cooling processing based on the temperature T or the humidity H. When the cooling processing is executed based on the temperature T, the CPU 41 may omit S7 to S9 in the cooling control processing. In this case, the image formation device 1 need not necessarily be provided with the humidity sensor 56. When the cooling processing is executed based on the humidity H, the CPU 41 may omit S2 to S6 in the cooling control processing. In this case, the image formation device 1 need not necessarily be provided with the temperature sensor 55.

In the above-described embodiment, the temperature sensor 55 is provided in the pre-treatment agent flow path 27, but the configuration is not limited to this example. The temperature sensor 55 may be provided at any one of the platen 15, the tank 77, the pre-treatment agent supply portion 61, or the head 14A. The temperature sensor 55 may detect the temperature of the pre-treatment agent 80 applied to the recording medium. The temperature sensor 55 may detect the temperature of the surroundings of the image formation device 1. In the above-described embodiment, the humidity sensor 56 is provided at the frame body 10, and detects the humidity H inside the housing 2, but the configuration is not limited to this example. The humidity sensor 56 may detect the humidity outside the housing 2. The image formation device 1 need not necessarily include the temperature sensor 55 or the humidity sensor 56. The image formation device 1 need not necessarily include the temperature sensor 55 and the humidity sensor 56.

In the cooling control processing, the CPU 41 may perform the processing (S7) of the control based on the humidity H before performing the processing (S3, S5) of the control based on the temperature T. In this case, the order of S4, S6, S9, and S10 is also changed. The CPU 41 may execute S5 before S3. In this case, the order of S4 and S6 is changed.

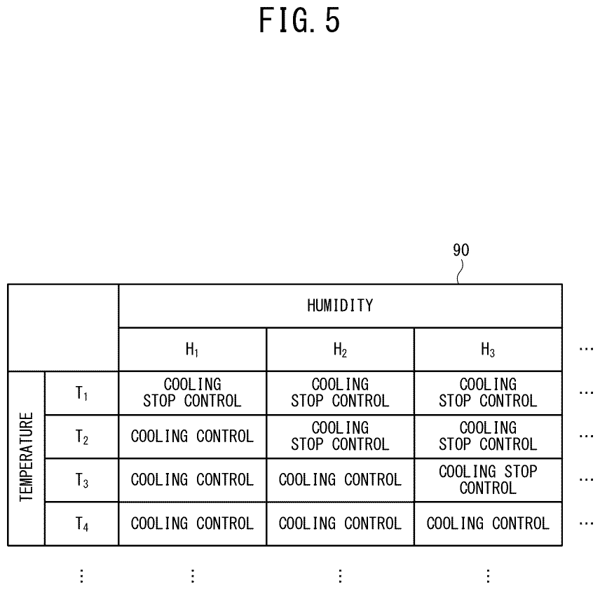

The CPU 41 may control the cooling of the pre-treatment agent 80 by the cooling portions 70 in accordance with a combination of the temperature T detected by the temperature sensor 55 and the humidity H detected by the humidity sensor 56. In this case, a pre-setting table 90 shown in FIG. 5 is stored in the flash memory 44. In the pre-setting table 90, control information indicating whether to perform the cooling processing or to perform the cooling stop processing is associated with combinations of the temperature T and the humidity H. In the cooling control processing, when the temperature T and the humidity H are acquired, based on the pre-setting table 90, the CPU 41 executes one of the cooling processing and the cooling stop processing, based on the control information associated with the acquired combination of the temperature T and the humidity H.

The CPU 41 need not necessarily control the cooling portions 70 based on the operating time in the predetermined time period of the image formation device 1. In this case, the CPU 41 may omit S1, S11, and S12 in the cooling processing. The cooling start timing is not limited to that of the above-described embodiment. The cooling start timing may be determined based on the operating time of the image formation device 1 in one week, for example. The cooling start timing may be determined based on a time at which the print processing is started in the one day. The CPU 41 may determine the cooling start timing based on the operating time of the image formation device 1 in the past. In this case, the CPU 41 may determine the cooling start timing during the execution of the cooling control processing (during a period in which the processing is returned from S12 to S1, for example).

The cooling end timing is not limited to that of the above-described embodiment. The cooling end timing may be determined based on the operating time of the image formation device 1 in one week, for example. The cooling end timing may be determined based on a time at which the pre-treatment processing ends in the one day. The CPU 41 may determine the cooling end timing based on the operating time of the image formation device 1 in the past. In this case, the CPU 41 may determine the cooling end timing during the execution of the cooling control processing (during the period in which the processing is returned from S12 to S1, for example).

A stand-by time may be stored in the flash memory 44 in placed of the cooling start timing. In this case, at S1, the CPU 41 may determine whether or not the stand-by time has elapsed. When the stand-by time has elapsed, the CPU 41 may perform the processing from S2 to S11. For example, when the stand-by time is one hour, the CPU 41 performs the cooling control processing each hour. In this way, the CPU 41 may regularly perform the cooling control processing.

In the cooling control processing, the CPU 41 may perform the processing from S2 to S11 in an irregular manner. In other words, the CPU 41 need not necessarily perform the processing from S2 to S11 at the determined timing such as the cooling start timing. For example, the CPU 41 may perform the processing from S2 to S11 when the user operates the operation portion 57 and inputs a cooling start command to the image formation device 1.

An execution time may be stored in the flash memory 44 in place of the cooling end timing. In this case, at S11, the CPU 41 may perform S12 when the execution time has elapsed from the cooling start timing.

In the cooling control processing, the CPU 41 may perform S12 in an irregular manner. In other words, the CPU 41 need not necessarily perform S12 at the determined timing such as the cooling end timing. For example, the CPU 41 may perform the processing at S12 when the user operates the operation portion 57 and inputs a cooling stop command to the image formation device 1.

The lower limit temperature T_{L} may be lower than the solidifying point of the pre-treatment agent 80. For example, the cooling portion 75 may perform the cooling at a temperature lower than the solidifying point of the pre-treatment agent 80. The image formation device 1 may melt the pre-treatment agent 80 that has been solidified by the cooling portions 70, by using a heater, for example, to cause the pre-treatment agent 80 to be at a temperature equal to or higher than a melting point thereof. The lower limit temperatures T_{L} of the cooling portions 71 to 75 may be the same as each other, or may be different from each other. The lower limit temperature T_{L} may be changed based on the temperature, the humidity, or an air pressure inside the housing 2, for example. The upper limit temperatures T_{H} of the cooling portions 71 to 75 may be the same as each other, or may be different from each other. The upper limit temperature T_{H} may be changed based on the temperature, the humidity, or the air pressure inside the housing 2, for example.

The lower limit humidity H_{L} of the cooling portions 71 to 75 may be the same as each other, or may be different from each other. The lower limit humidity H_{L} may be changed based on the temperature, the humidity, or the air pressure inside the housing 2, for example.

In place of the CPU 41, a microcomputer, application specific integrated circuits (ASICs), a field programmable gate array (FPGA) or the like may be used as a processor. The cooling control processing may be performed as distributed processing by a plurality of the processors. It is sufficient that the non-transitory storage media, such as the ROM 42, the flash memory 44, and the like be a storage medium capable of storing information, regardless of a period of storing the information. The non-transitory storage medium need not necessarily include a transitory storage medium (a transmitted signal, for example). The control program may be downloaded from a server connected to a network (not shown in the drawings) (in other words, may be transmitted as transmission signals), and may be stored in the ROM 42 or the flash memory 44. In this case, the control program may be stored in a non-transitory storage medium, such as an HDD provided in the server.

What is claimed is:

1. An image formation device comprising:
a head configured to discharge ink; and
a cooling portion configured to cool a pre-treatment agent, the pre-treatment agent containing a volatile component having volatility, and reacting with the ink.

2. The image formation device according to claim 1, further comprising:
a discharge portion configured to discharge the pre-treatment agent, wherein
the cooling portion cools the pre-treatment agent in advance of being discharged from the discharge portion.

3. The image formation device according to claim 1, further comprising:
a storage portion configured to store the pre-treatment agent, wherein
the cooling portion cools the pre-treatment agent stored in the storage portion.

4. The image formation device according to claim 3, wherein
the storage portion includes a heat insulating material.

5. The image formation device according to claim 2, further comprising:
a storage portion configured to store the pre-treatment agent, wherein
the cooling portion cools the pre-treatment agent inside a flow path connecting the storage portion and the discharge portion.

6. The image formation device according to claim 2, wherein
the cooling portion cools the pre-treatment agent inside the discharge portion.

7. The image formation device according to claim 1, further comprising:
a platen configured to support a recording medium to which the pre-treatment agent is applied, wherein
the cooling portion cools the pre-treatment agent applied to the recording medium, via the platen.

8. The image formation device according to claim 1, further comprising:
a processor; and
a memory storing computer-readable instructions that, when executed by the processor, instruct the processor to perform processes including:
controlling the cooling portion, and causing the cooling portion to cool the pre-treatment agent in at least one of a case in which a temperature measured by a thermometer measuring the temperature is equal to or higher than a predetermined temperature, or a case in which a humidity measured by a hygrometer measuring the humidity is equal to or lower than a predetermined humidity.

9. The image formation device according to claim 1, further comprising:
a processor; and
a memory storing computer-readable instructions that, when executed by the processor, instruct the processor to perform processes including:
controlling the cooling portion based on an operating time of the image formation device in a predetermined time period.

10. The image formation device according to claim 1, further comprising:
the cooling portion cools the pre-treatment agent to cause the temperature of the pre-treatment agent to be higher than a solidifying point of the pre-treatment agent.
